(19) United States
(12) Patent Application Publication
(10) Pub. No.: US 2006/0152515 A1
(43) Pub. Date: Jul. 13, 2006

(54) Host device, display system and method of generating DPVL packet

(75) Inventors: In-hye Lee, Suwon-si (KR); Young-chan Kim, Uiwang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/318,619

(22) Filed: Dec. 28, 2005

(30) Foreign Application Priority Data
Jan. 13, 2005 (KR) 2005-0003328

(51) Int. Cl. G06F 13/00

(52) U.S. Cl. 345/537

(57) ABSTRACT

The present invention relates to a host device supporting DPVL standards having a frame buffer, a graphic engine to store video data as a unit of frame in the frame buffer, and a host controller to detect a plurality of update areas corresponding to the video data of a current frame changed from a previous frame, read out the video data corresponding to the detected update area from the frame buffer, and generate a DPVL packet including identification information about the read video data and each update area. Thus, the amount of video data included in the DPVL packet according to DPVL standards is minimized to enhance transmission speed.

### PRIORITY

This application claims the benefit under 35 U.S.C. §119(a) of Korean Patent Application No. 2005-0003328, filed on Jan. 13, 2005, in the Korean Intellectual Property Office, the entire contents of which are incorporated herein by reference.

### BACKGROUND OF THE INVENTION

1. Field of the Invention

The present invention relates to a host device, a display system and a method of generating a digital packet video link (DPVL) packet. More particularly, the present invention relates to a host device, a display, a display system and a method of generating a DPVL packet in which the amount of video data included in the DPVL packet according to DPVL standards is minimized to enhance transmission speed.

2. Description of the Related Art

As technology for manufacturing a display device such as a monitor has improved, there is a tendency to provide the display device with high specifications such as a high density, a large number of pixels and the like.

However, there are various limitations to achieving wide use of this high specification display device. One of the limitations is a requirement for an interface between the display device and a host device due to the display device requiring a high transmission bandwidth as compared with an existing display device.

To satisfy the interface requirement in the high specification display device, digital packet video link (DPVL) standards have been proposed by video electronics standard associations (VESA).

FIG. 1 is a control block diagram of a conventional display system supporting the DPVL standards. As shown therein, a display system supporting the DPVL standards comprises a host device 110 and a display device 130.

The host device 110 comprises a frame buffer 113, a graphic engine 111 for generating video data and storing the video data in the frame buffer 113 in units of frames, and a host controller 112 for reading out the video data corresponding to an update area (TUA) (refer to FIG. 2) within a current frame from the frame buffer 113 and generating a DPVL packet. Here, the update area TUA indicates a changed image within the current frame as compared with a previous frame.

The display device 130 comprises a frame buffer 133, and a display controller 132 for detecting the video data out of the DPVL packet received from the host device 110, storing the video data in the frame buffer 133, and controlling a display module 131 to display an image based on the video data corresponding to one frame stored in the frame buffer 133.

According to the DPVL standards, the host device 110 and the display device 130 are connected through a digital video interface (DVI) standard proposed by a digital display working group (DDWG).

Further, the DPVL standards propose that one update area TUA is set per frame. For example, as shown in FIG. 2, when two small areas UA1 and UA2 separated from each other are changed on one screen, the DPVL standards propose that an area including both separated small areas UA1 and UA2 is set as the update area TUA.

However, as shown in FIG. 2, when proportions of the areas UA1 and UA2 including the changed image corresponding to the total update area (TUA) are small as compared with the other area UCA including an unchanged image, the video data corresponding to the unchanged image area UCA occupying most of the update area TUA is unnecessarily included in the DPVL packet and then transmitted. Hence, it is counterproductive to the goal of the DPVL standards to enhance transmission speed by decreasing the amount of the video data transmitted from the host device 110 to the display device 130. A need therefore exists for a system and method of generating a DPVL packet in which the amount of video data included in the DPVL packet according to DPVL standards is minimized to enhance transmission speed.

### SUMMARY OF THE INVENTION

Accordingly, it is an object of the present invention to provide a host device, a display, a display system and a method of generating a DPVL packet in which the amount of video data included in the DPVL packet according to DPVL standards is minimized to enhance transmission speed.

The foregoing and/or other exemplary aspects of the present invention are achieved by providing a host device supporting DPVL standards which comprises a frame buffer, a graphic engine to store video data in units of frames in the frame buffer, and a host controller to detect a plurality of update areas corresponding to the video data of a current frame changed from a previous frame, read out the video data corresponding to the detected update area from the frame buffer, and generate a DPVL packet comprising identification information about the read video data and each update area.

According to an exemplary aspect of the present invention, the host controller generates the DPVL packet as a unit of each update area.

According to an exemplary aspect of the present invention, the identification information about each update area comprises information about a frame corresponding to each update area.

According to an exemplary aspect of the present invention, the host controller calculates the proportion of the plurality of update areas to a total update area including all the plurality of update areas, and generates the DPVL packet corresponding to the total update area when the calculated proportion is beyond a predetermined reference proportion.

The foregoing and/or other exemplary aspects of the present invention are achieved by a display system supporting DPVL standards comprising a host device to generate a DPVL packet that comprises identification information about a plurality of update areas corresponding to video data of a current frame changed from a previous frame, and the video data corresponding to each update area, and a display device comprising a display module to display an image thereon, a frame buffer to store video data in units of frames, and a display controller to store the video data corresponding to the plurality of update areas within the current frame in the frame buffer on the basis of the identification information included in the DPVL packet received from the host device and control the display module to display an image based on the video data about the current frame stored in the frame buffer.

According to an exemplary aspect of the present invention, the host controller generates the DPVL packet as a unit of each update area.

According to an exemplary aspect of the present invention, the identification information about each update area comprises information about a frame corresponding to each update area, and the display controller stores the video data of at least one DPVL packet in the frame buffer as the video data of the current frame on the basis of the information about the frame including each update area.

The foregoing and/or other exemplary aspects of the present invention are achieved by providing a method of generating a DPVL packet satisfying DPVL standards, the method comprising detecting a plurality of update areas corresponding to video data of a current frame changed from a previous frame, and generating the DPVL packet comprising identification information about the video data of each detected update area and about each update area.

According to an exemplary aspect of the present invention, the DPVL packet is generated as a unit of each update area.

According to an exemplary aspect of the present invention, the identification information about each update area comprises information about the frame corresponding to each update area.

According to an exemplary aspect of the present invention, the method further comprises calculating proportion of the plurality of update areas to a total update area including all the plurality of update areas, and generating a DPVL packet corresponding to the total update area when the calculated proportion is beyond a predetermined reference proportion.

### BRIEF DESCRIPTION OF THE DRAWINGS

These and other aspects and advantages of the present invention will become apparent and more readily appreciated from the following description of the exemplary embodiments, taken in conjunction with the accompany drawings of which:

FIG. 1 is a control block diagram of a conventional display system supporting digital packet video link (DPVL) standards;

FIGS. 2 and 4 are views showing update areas in accordance with an exemplary embodiment of the present invention;

FIG. 3 is a control block diagram of a display system according to an exemplary embodiment of the present invention supporting the DPVL standards; and

FIG. 5 is a control flowchart of generating a DPVL packet in the display system according to an exemplary embodiment of the present invention.

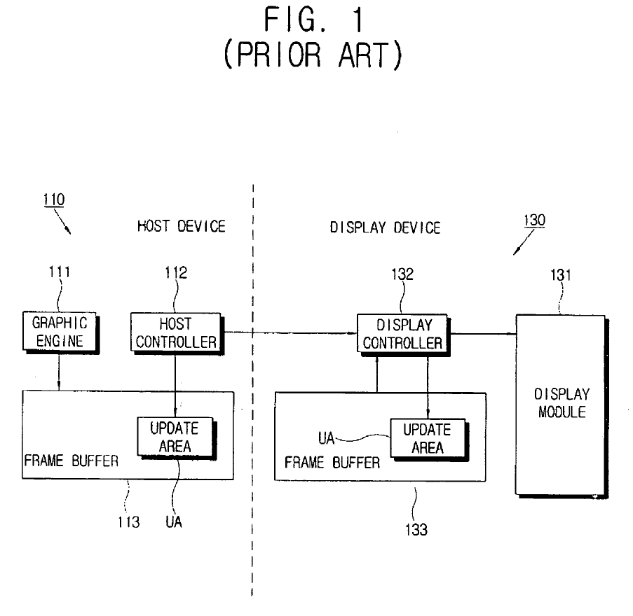

Throughout the drawings, the same or similar elements are denoted by the same reference numerals.

### DETAILED DESCRIPTION OF THE EXEMPLARY EMBODIMENTS

Reference will now be made in detail to the embodiments of the present invention, examples of which are illustrated in the accompanying drawings.

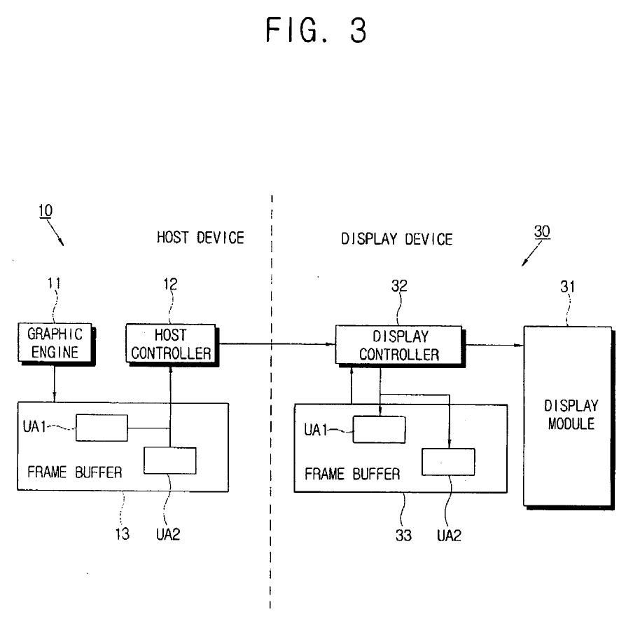

A display system according to an exemplary embodiment of the present invention supports digital packet video link (DPVL) standards of video electronics standard associations (VESA). The display system comprises a host device 10 and a display device 30 as shown in FIG. 3.

The host device 10 comprises a frame buffer 13, a graphic engine 11, and a host controller 12.

The graphic engine 11 generates video data to be displayed as an image on the display device 30, and stores the video data in the frame buffer 13 in units of frames.

The host controller 12 detects a plurality of update areas UA1 and UA2 including the video data of a current frame changed from a previous frame on the basis of the video data stored in the frame buffer 13.

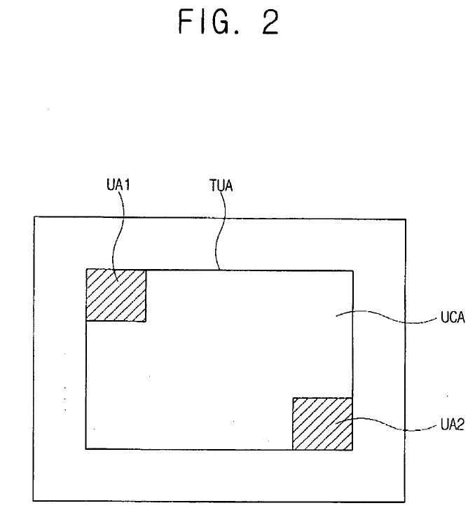

Referring to FIG. 2, when an area corresponding to the video data changed between the current frame and the previous frame is separated into a plurality of areas, the host controller 12 detects the update areas UA1 and UA2 corresponding to the plurality of areas.

Further, the host controller 12 reads out the video data corresponding to the detected update areas UA1 and UA2 from the frame buffer 13, and generates DPVL packets corresponding to the update areas UA1 and UA2, respectively. At this time, the host controller 12 controls the DPVL packets to comprise identification information about the respective update areas UA1 and UA2.

Here, the host controller 12 according to an exemplary embodiment of the present invention generates the DPVL packet as a unit of each update area UA1, UA2. For example, as shown in FIG. 2, when the host controller 12 detects two update areas UA1 and UA2 with respect to one frame, the host controller 12 generates the DPVL packets corresponding to the update areas UA1 and UA2, respectively.

Further, the identification information contains information about the frame including the update areas UA1 and UA2 corresponding to the DPVL packets. Here, the identification information is recorded in an extra space of a header provided in the DPVL packet based on the DPVL standard of the VESA.

Thus, the host controller 12 controls the DPVL packets corresponding to the respective update areas UA1 and UA2 to comprise the identification information about the frame having the corresponding update areas UA1 and UA2, thereby allowing the display device 30 to recognize that two DPVL packets are used in forming one frame.

Meanwhile, when the plurality of update areas UA1 and UA2 are set with respect to one frame, the host controller 12 calculates the proportion of the plurality of update areas UA1 and UA2 to a total update area TUA including all update areas UA1 and UA2. Further, when the calculated proportion is beyond a predetermined reference proportion, the host controller 12 does not generate the DPVL packets corresponding to the respective update areas UA1 and UA2, and generates the DPVL packet corresponding to the total update area TUA.

For example, when two update areas UA1 and UA2 are set with respect to one frame, the host controller 12 calculates the proportion of two update areas UA1 and UA2 to the total update area TUA including all set update areas UA1 and UA2. When the calculated proportion is equal to or below a predetermined reference proportion, that is, when the proportion of the unchanged image area UCA to the total update area TUA is relatively larger than that of two update areas UA1 and UA2 as shown n FIG. 2, the host controller 12 generates the DPVL packets corresponding to two update areas UA1 and UA2, respectively.

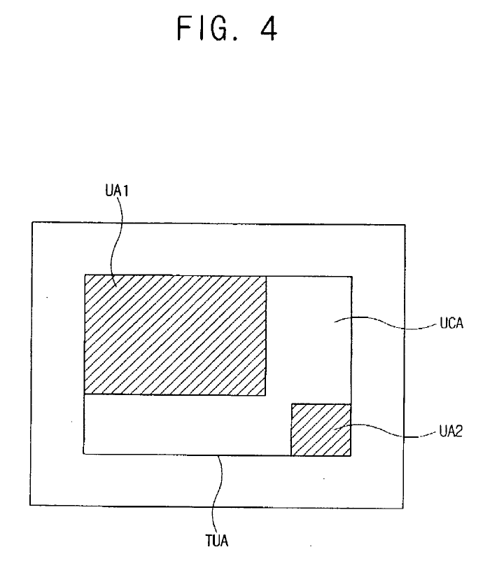

On the other hand, when the calculated proportion is beyond a predetermined reference proportion, that is, when the proportion of the unchanged image area UCA to the total update area TUA is relatively smaller than that of two update areas UA1 and UA2 as shown in FIG. 4, the host controller 12 sets the total update area TUA as one update area including two update areas UA1 and UA2 and generates the DPVL packet corresponding to the total update area TUA.

Thus, the plurality of update areas UA1 and UA2 is set according to the proportions of the unchanged image area UCA to one frame.

Referring to FIG. 3, the display device 30 according to an embodiment of the present invention comprises a display module 31, a frame buffer 33, and a display controller 32.

The display module 31 displays an image thereon on the basis of a video signal outputted from the display controller 32. Here, the display module 31 can include various modules such as a liquid crystal display (LCD) module, a plasma display panel (PDP) module, and the like as long as it can display an image based on the video signal outputted from the display controller 32.

The frame buffer 33 has a storage space to store the video data corresponding to one frame. Here, the frame buffer 33 satisfies the DPVL standards of VESA.

The display controller 32 controls the video data corresponding to the plurality of update areas UA1 and UA2 within the current frame to be stored in the frame buffer 33 on the basis of the identification information included in the DPVL packet transmitted from the host device 10.

For example, when the display controller 32 receives the DPVL packet from the host device 10, the display controller 32 determines which frame corresponds the update areas UA1 and UA2 of the DPVL packet on the basis of the identification information included in the DPVL packet. For example, when the display controller 32 receives two DPVL packets with respect to one frame from the host device 10 as shown in FIG. 2, the display controller 32 determines that two received DPVL packets belongs to one frame on the basis of the identification information included in each DPVL packet.

Further, the display controller 32 stores the video data of two DPVL packets in the frame buffer 33 in sequence. After the video data of two DPVL packets is completely stored in the frame buffer 33, the display controller 32 reads out the entire video data from the frame buffer 33, thereby displaying an image on the display module 31.

On the other hand, when the display controller 32 receives the DPVL packet corresponding to the total update area TUA set per frame from the host device 10, the display controller 32 can store the video data corresponding to one received DPVL packet in the frame buffer 33 and read out the entire video data from the frame buffer 33, thereby displaying an image on the display module 31.

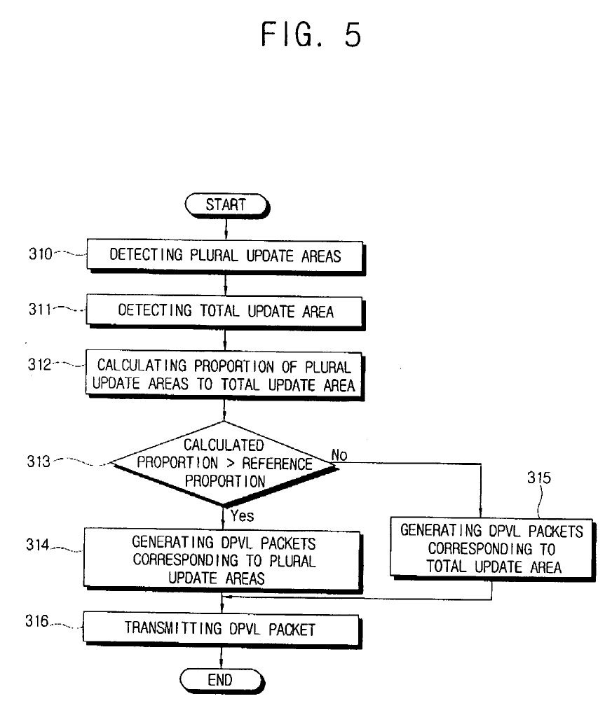

Herein below, in the display system according to an embodiment of the present invention, a method of generating the DPVL packet will be described with reference to FIG. 5.

First, at operation 310, the host controller 12 of the host device 10 detects the plurality of update areas UA1 and UA2 corresponding to the video data of the current frame changed from the previous frame.

At operation 311, the host controller 12 detects the total update area TUA including all the plurality of update areas UA1 and UA2. At operation 312, the host controller 12 calculates the proportion of the plurality of update areas UA1 and UA2 to the total update area TUA.

At operation 313, the host controller 12 determines whether the calculated proportion is beyond the reference proportion. When the calculated proportion is beyond the reference proportion, the host controller 12, at operation 314, generates the DPVL packets corresponding to the plurality of update areas UA1 and UA2 and, at operation 316, transmits the DPVL packets to the display device 30.

On the other hand, when the calculated proportion is equal to or below the reference proportion, the host controller 12, at operation 315, generates the DPVL packet corresponding to the total update area TUA, and at operation 316, transmits the DPVL packet to the display device 30.

Alternatively, the host controller 12 may first detect the total update area TUA and then detect the plurality of update areas UA1 and UA2 within the detected total update area TUA.

As described above, the present invention provides a host device, a display, a display system and a method of generating a DPVL packet, in which the amount of video data included in the DPVL packet according to DPVL standards is minimized to enhance transmission speed.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A host device supporting DPVL standards, comprising:
a frame buffer;
a graphic engine to store video data as a unit of frame in the frame buffer; and
a host controller to detect a plurality of update areas corresponding to the video data of a current frame changed from a previous frame, read out the video data corresponding to the detected update area from the frame buffer, and generate a DPVL packet comprising identification information about the read video data and each update area.

2. The host device according to claim 1, wherein the host controller generates the DPVL packet as a unit of each update area.

3. The host device according to claim 2, wherein the identification information about each update area comprises information about a frame corresponding to each update area.

4. The host device according to claim 3, wherein the host controller calculates proportion of the plurality of update areas to a total update area including all the plurality of update areas, and generates the DPVL packet corresponding to the total update area when the calculated proportion is beyond a predetermined reference proportion.

5. A display system supporting DPVL standards, comprising:
a host device to generate a DPVL packet that includes identification information about a plurality of update areas corresponding to video data of a current frame changed from a previous frame, and the video data corresponding to each update area; and
a display device comprising a display module to display an image thereon, a frame buffer to store video data as a unit of frame, and a display controller to store the video data corresponding to the plurality of update areas within the current frame in the frame buffer on the basis of the identification information included in the DPVL packet received from the host device and control the display module to display an image based on the video data about the current frame stored in the frame buffer.

6. The display system according to claim 5, wherein the host controller generates the DPVL packet as a unit of each update area.

7. The display system according to claim 6, wherein the identification information about each update area comprises information about a frame corresponding to each update area, and
the display controller stores the video data of at least one DPVL packet in the frame buffer as the video data of the current frame on the basis of the information about the frame including each update area.

8. A method of generating a DPVL packet satisfying DPVL standards; the method comprising:
detecting a plurality of update areas corresponding to video data of a current frame changed from a previous frame; and
generating the DPVL packet comprising identification information about the video data of each detected update area and about each update area.

9. The method according to claim 8, wherein the DPVL packet is generated as a unit of each update area.

10. The method according to claim 9, wherein the identification information about each update area comprises information about the frame corresponding to each update area.

11. The method according to claim 10, further comprising:
calculating proportion of the plurality of update areas to a total update area including all the plurality of update areas; and
generating a DPVL packet corresponding to the total update area when the calculated proportion is beyond a predetermined reference proportion.
